(19) United States
(12) Patent Application Publication
(10) Pub. No.: US 2008/0002711 A1
(43) Pub. Date: Jan. 3, 2008

(54) System and method for access state based service options

(76) Inventor: Michael K. Bugenhagen, Olathe, KS (US)

Correspondence Address: PATTON BOGGS, L.L.P., 2001 ROSS AVENUE, SUITE 3000, DALLAS, TX, 75201, US

(21) Appl. No.: 11/479,751

(22) Filed: Jun. 30, 2006

(51) Int. Cl. H04L 12/56

(52) U.S. Cl. 370/395.2

(57) ABSTRACT

A method of operating a service provider system comprises receiving a state message from an access system indicating state information for access wherein the access system provides a device with the access, receiving a service request from the device identifying the device and the service, determining a plurality of service options for the service based on the state message, generating a service response indicating the plurality of service options, and transmitting the service response.

### RELATED APPLICATIONS

Not applicable

### FEDERALLY SPONSORED RESEARCH OR DEVELOPMENT

Not applicable

### MICROFICHE APPENDIX

Not applicable

### BACKGROUND OF THE INVENTION

1. Field of the Invention

The invention relates to telecommunications, and in particular, to determining service options for communication services based on access state information.

2. Description of the Prior Art

The recent increase in the availability and popularity of real-time voice, video, and data services has presented new challenges to providers of such services. In one problem, the state of the first-mile access links to end user systems frequently determines the quality of service enjoyed by an end user during a service session. Unfortunately, service providers typically do not have access to access link state information, such as the bandwidth available to any one particular customer modem. As a result, service providers are forced to provide services to end users at sub-optimal configurations.

In the prior art, some access systems are capable of determining and providing operations and management metrics to a network operations center detailing access link state information. For example, the IEEE 802.3AH standard was created to enable operations and management resources to monitor Ethernet links. However, even when service providers are provided access state information, such information is not utilized in an interactive manner with the end user to optimize session experiences.

### SUMMARY OF THE INVENTION

An embodiment of the invention helps solve the above problems and other problems by providing systems, methods, and software that allow an end user to communicate with a service provider regarding service options for a requested service whereby the service options are determined based on the quality of the access currently enjoyed by the end user. Depending upon access state information provided to the service provider by the end user's access system, the service provider determines various service options for the user. The end user then selects one of the options and the service provider configures the service going forward in accordance with the selected option. In this manner, the end user is involved in the service provisioning and optimization process.

In an embodiment of the invention, a communication network comprises a device, an access system configured to provide the device with access to a service, and a service provider system configured to provide the service to the device. The access system transmits a state message indicating state information for the access. The device transmits a service request to the service provider system identifying the device and the service. The service provider system receives the service request, determines a plurality of service options for the service based on the state message, generates a service response indicating the plurality of service options, and transmits the service response.

In an embodiment, the device receives the service response, generates a selection message indicating a one service option of the plurality of service options, and transmits the selection message.

In an embodiment, the service provider system receives the selection message and configures the service for the one service option.

In an embodiment, the state information comprises available bandwidth.

In an embodiment, the plurality of service options comprises a plurality of coding/decoding protocols.

In an embodiment, the access system comprises a modem.

In an embodiment, the service comprises a video service.

In an embodiment, the service comprises a voice service.

In an embodiment of the invention, an end user system comprises an access system configured provide an access link to a communication network, monitor the access link, determine access state information for the access link, and transmit a state message indicating the access state information. The end user system further comprises a device coupled to the access system and configured to transmit a service request for a service provided by a service provider system, receive service options from the service provider system in response to the service request wherein the service provider system determines the service options based on the access state information, select a one service option of the service options, and transmit a selection message identifying the one service option.

In an embodiment of the invention, a method of operating a service provider system comprises receiving a state message from an access system indicating state information for access wherein the access system provides a device with the access, receiving a service request from the device identifying the device and the service, determining a plurality of service options for the service based on the state message, generating a service response indicating the plurality of service options, and transmitting the service response.

### BRIEF DESCRIPTION OF THE DRAWINGS

The same reference number represents the same element on all drawings.

FIG. 1 illustrates a communication network in an embodiment of the invention.

FIG. 2 illustrates the operation of a communication network in an embodiment of the invention.

FIG. 3 illustrates the operation of a communication network in an embodiment of the invention.

FIG. 4 illustrates the operation of a service provider system in an embodiment of the invention.

FIG. 5 illustrates a communication network in an embodiment of the invention.

FIG. 6 illustrates the operation of a communication network in an embodiment of the invention.

FIG. 7 illustrates the operation of a communication network in an embodiment of the invention.

FIG. 8 illustrates the operation of a service provider system in an embodiment of the invention.

FIG. 9 illustrates a computer system in an embodiment of the invention.

### DETAILED DESCRIPTION OF THE PREFERRED EMBODIMENT

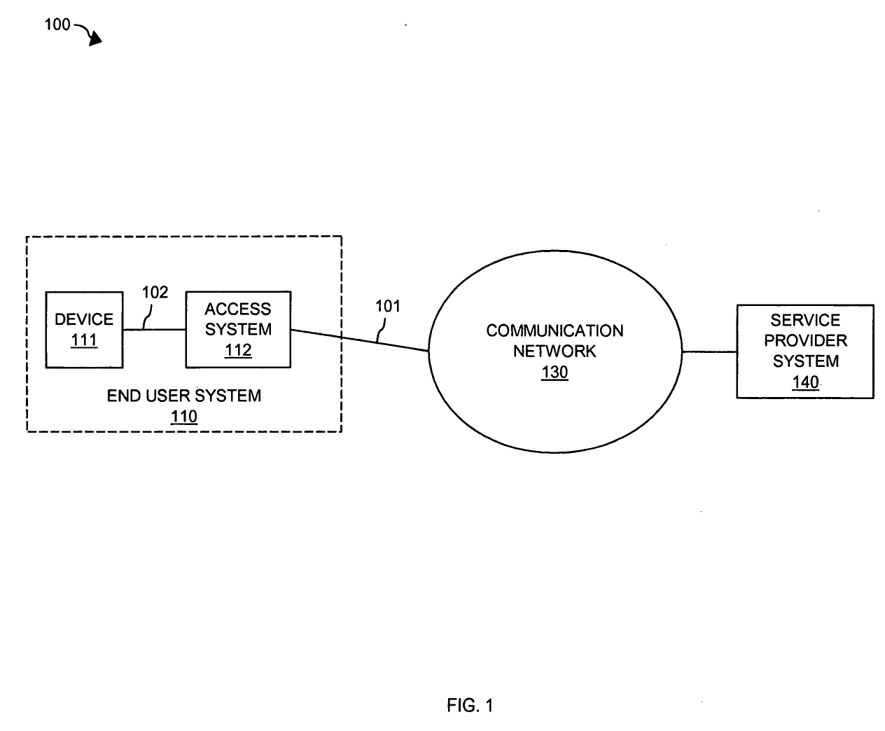

FIGS. 1-9 and the following description depict specific embodiments of the invention to teach those skilled in the art how to make and use the best mode of the invention. For the purpose of teaching inventive principles, some conventional aspects have been simplified or omitted. Those skilled in the art will appreciate variations from these embodiments that fall within the scope of the invention. Those skilled in the art will appreciate that the features described below can be combined in various ways to form multiple embodiments of the invention. As a result, the invention is not limited to the specific embodiments described below, but only by the claims and their equivalents.

FIG. 1 illustrates communication network 100 in an embodiment of the invention. Communication network 100 includes end user system 110, communication network 130, and service provider system 140. End user system 110 includes access system 112 and device 111. Access system 112 is coupled to communication network 130. Likewise, service provider system 140 is coupled to communication network 130.

Access system 112 could be any system capable of providing device 111 with access to services provided over communication network 130. Service provider system 140 could be any system capable of providing services to device 111. Device 111 could be any type of device capable of communicating with service provider system 140 through access system 112 and communication network 130, such as a personal computer, a mobile phone. Examples of services could include voice, video, and data services, as well as other types of service. It should be understood that communication network 130 could be any network or collection of networks capable of transporting communications between access system 112 and service provider system 140.

Device 111 is coupled to access system 112 by communication link 102. Communication link 102 could be a wired or wireless link, such as a CAT-5 cable, USB cable, or WiFi wireless connection. Access system 112 is coupled to communication network by communication link 101. Communication link 101 could also be wireline or wireless link. For example, communication link 401 could comprise a DSL connection or a cable connection, as well as any other type of wireline access link. In another example, communication link 101 could comprise a CDMA, MMDS, EVDO, or WiMax link, as well as any combination thereof or any other type of wireless access link.

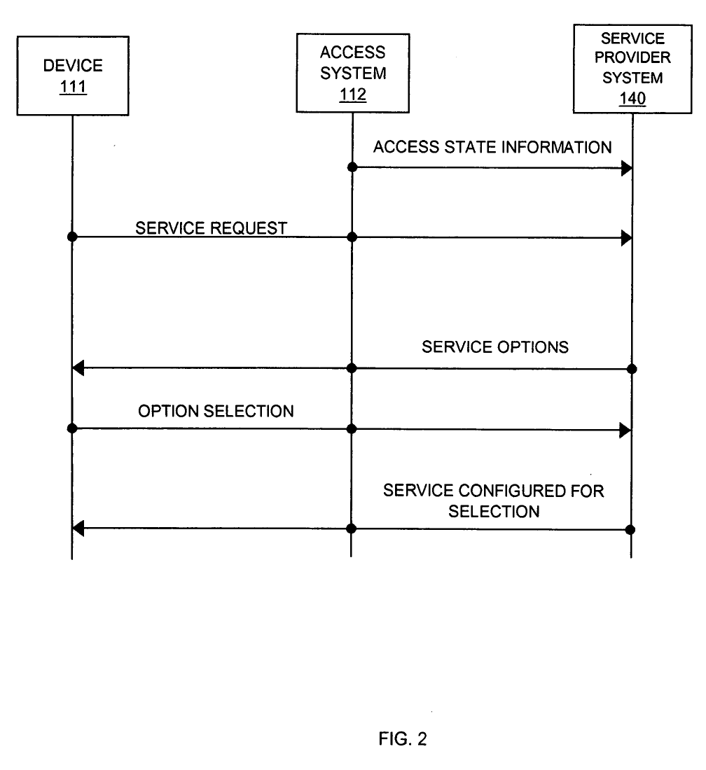

FIG. 2 illustrates the operation of communication network 100. In operation, device 111 communicates with access system 112 to initiate and setup an access link to communication network 130. Upon establishing access to communication network 130, access system 112 monitors communication link 101 for access state information. For example, access system 112 measures the total bandwidth of link 101 and the amount of available bandwidth on link 101. Other metrics include jitter, delay, and reserved bandwidth. As illustrated by FIG. 2, access system 112 transmits the access state information to service provider system 140.

After access system 112 has transmitted the access state information to service provider system 140, device 111 initiates a service request to service provider system 140 for a service. Service provider system 140 responsively processes the service request, along with the access state information, to determine service options for the requested service. The service options could be determined based on the access state information. Service provider system 140 then transfers the service options to device 111 for selection. A user operatively selects one of the options from the service options and device 111 returns the selected option to service provider system 140. Service provider system 140 responsively provides the service configured for the option selection.

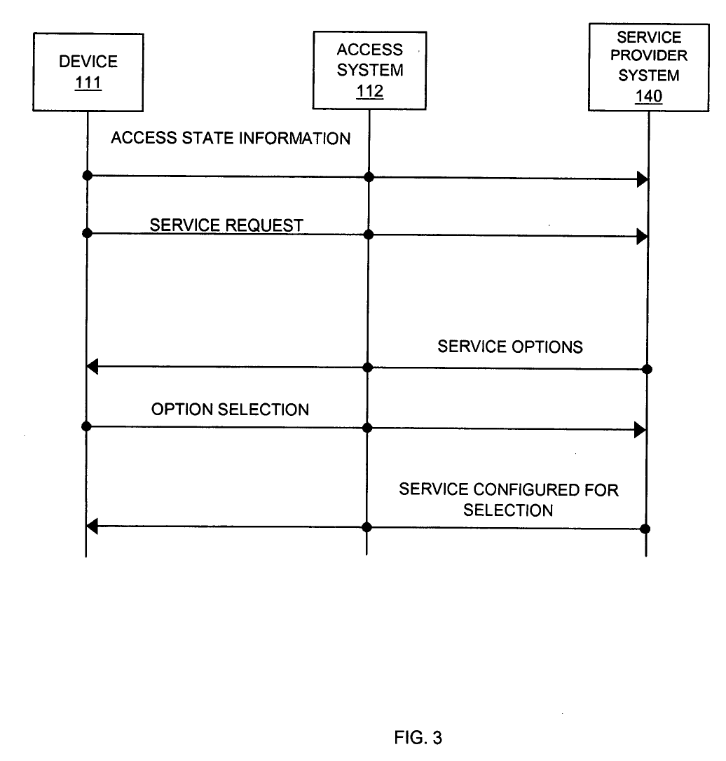

FIG. 3 illustrates the operation of communication network 100 in an embodiment of the invention. In operation, device 111 communicates with access system 112 to gain access to communication network 130. Upon establishing the access, device 111 monitors link 102. For example, device 111 could monitor for the total bandwidth available over link 102. Device 111 could also monitor general performance statistics, such as packet jitter and packet delay. The performance results, such as jitter or delay, could be indicative of the performance of link 102, link 101, or communication network 130. Importantly, device 111 determines by monitoring and detection the state of the access at device 111, regardless of whether any degradation is caused by link 102, link 101, or communication network 130. Device 111 then generates access state information pertaining to the health or status of the access as perceived by device 111 and transmits the access state information to service provider system 140.

Next, device 111 transmits a service request for a service to service provider system 140 identifying the service and device 111. Service provider system 140 receives the service request from device 111 and responsively provides service options to device 111. Device 111 provides the options to a user for selection, such as via a graphical user interface. The user selects one of the service options and device 111 transmits the selected option to service provider system 140. Upon receiving the selected option, service provider system 140 provides the requested service configured for the option selection.

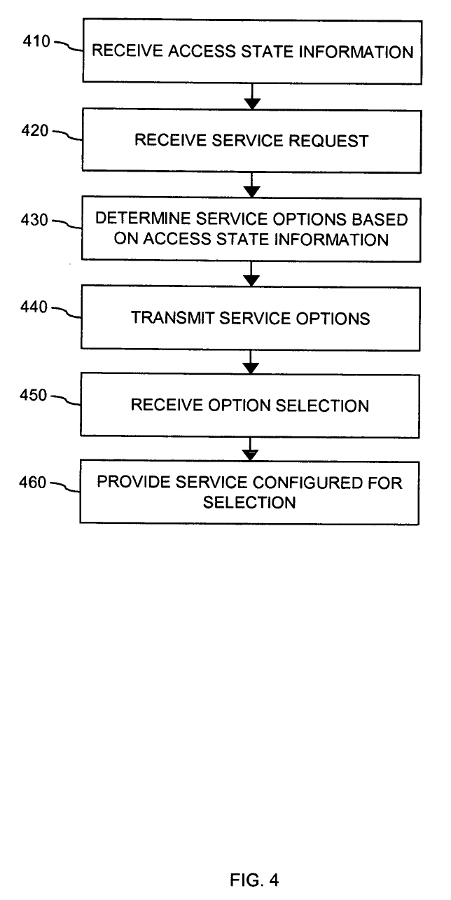

FIG. 4 illustrates the operation of service provider system 140 in an embodiment. To begin, service provider system 140 receives access state information indicate the state of an access link between an access system and a communication network (Step 410). The state information could include, for example, total bandwidth or available bandwidth, as well as other types of state information. Next, service provider system 140 receives a service request from a device whereby the device is provided access by the access system (Step 420). Service provider system 140 processes the service request with the access state information to determine service options based on the access state information (Step 430). Upon determining the service options, service provider system 140 transfers the service options to the device (Step 540). A user operatively selects one of the options and the device returns the selected option to service provider system 140. Service provider system 140 receives the selected option (Step 450) and provides the requested service configured for the selected option (Step 460).

Advantageously, communication network 100 allows for dynamically providing service options based on access state information to end users in an interactive manner. In particular, either the device or the access system monitors for and provides access state information on the access links to the service provider. The service provider then provides the end user with service options based on the access state information. The service is then configured and provided in accordance with the preference of the user.

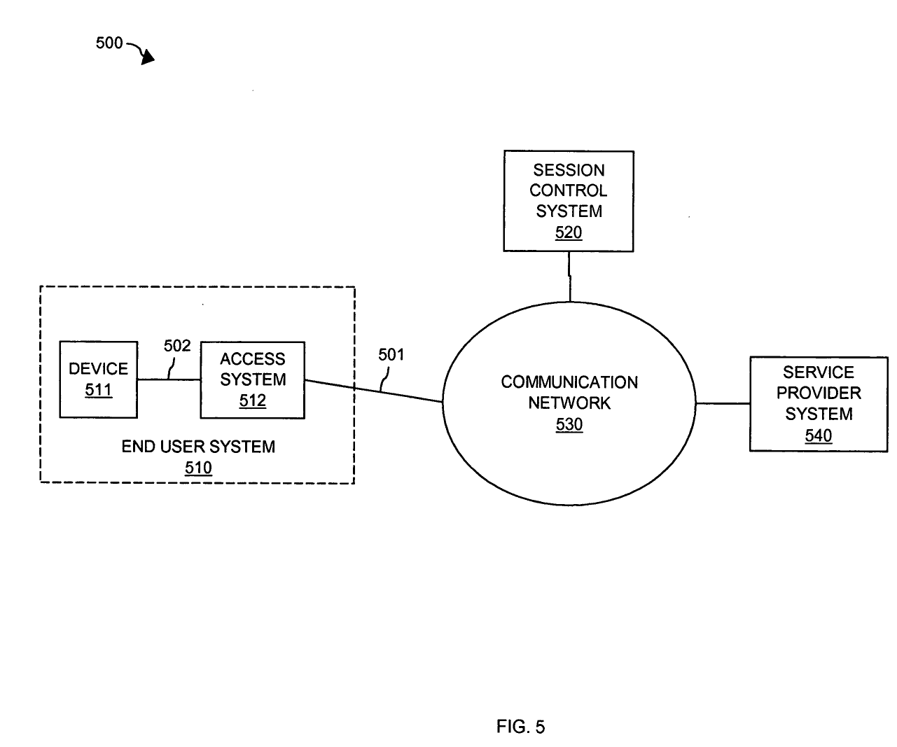

FIG. 5 illustrates communication network 500 in an embodiment of the invention. Communication network 500 includes end user system 510, communication network 530, session control system 520, and service provider system 540. End user system 510 includes device 511 and access system 512. Device 511 is coupled to access system 512 by communication link 502. Access system 512 is coupled to communication network 530 by communication link 501. Session control system 520 is coupled to communication network 530. Likewise, service provider system 540 is coupled to communication network 530.

Service provider system 540 could by any system capable of providing a service to device 511 over communication network 530. A service could be, for example, a voice, video, audio, or data service. Session control system 520 could be any system capable of controlling service sessions between service provider system 540 and device 511. Access system 512 could be any system capable of providing device 511 with access to communication network 530. In an example, access system 512 could be a cable modem, a digital subscriber line (DSL) modem, or the like. Device 511 could be any device capable of communicating with session control system 520 and service provider system 540, such as a personal computing device, a personal digital assistant, or a mobile phone, as well as other types of devices. Alternatively, device 511 may communicate directly with communication network 530 without the use of access system 512 or session control system 520. Communication link 502 could be a wired or wireless link, such as a CAT-5 cable, USB cable, or WiFi wireless connection. Communication link 501 could also be a wireline or wireless link. For example, communication link 501 could comprise a DSL connection, fiber connection, cable connection, wire connection, or any other suitable wired connection using any suitable communications protocol, either alone or in combination with other links. The term “wired connection” refers to a connection that is not a wireless connection, and is not meant to exclude connections such as connections using optical fiber that do not include actual wire. In another example, communication link 501 could comprise a CDMA, MMDS, EVDO, WiMax link, or other suitable wireless link using any suitable communications protocol, either alone or in combination with other links.

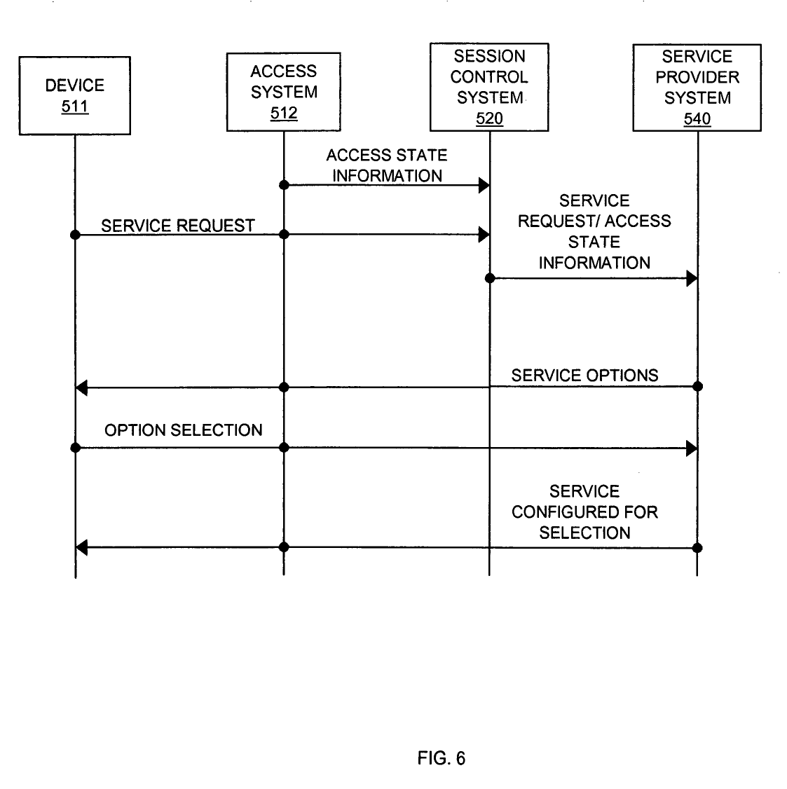

FIG. 6 illustrates the operation of communication network 500 in an embodiment of the invention. In operation, device 511 communicates with access system 512 to gain access to communication network 530. Upon establishing the access, access system 512 monitors link 501. Access system 512 generates access state information pertaining to the health or status of link 501. Access system 512 could also monitor link 502 and could generate access state information pertaining to the health or status of link 502. Access system 512 actively transmits the access state information to session control system 520. Access system 512 could transfer the access state information periodically.

Next, device 511 transmits a service request for a service to session control system 520 identifying the service and device 511. In response to the service request, session control system 520 transfers a service request to service provider system 540 indicating device 511, the requested service, and the access state information. Service provider system 540 receives the service request from session control system 520 and responsively provides service options to device 511. Device 511 provides the options to a user for selection, such as via a graphical user interface. The user selects one of the service options and device 511 transmits the selected option to service provider system 540. Upon receiving the selected option, service provider system 540 provides the requested service configured for the option selection.

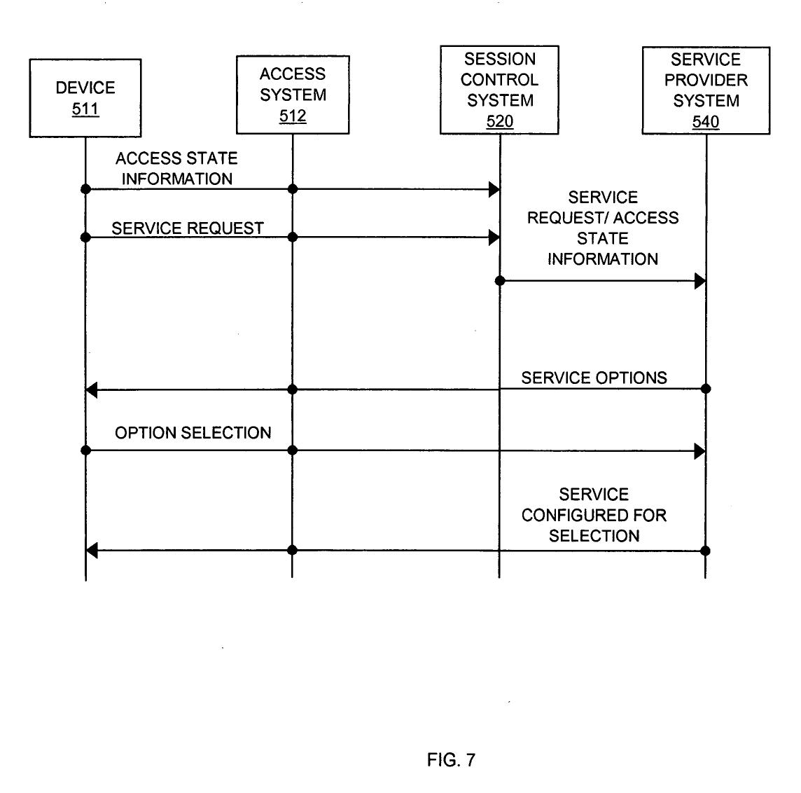

FIG. 7 illustrates the operation of communication network 500 in an embodiment of the invention. In operation, device 511 communicates with access system 512 to gain access to communication network 530. Upon establishing the access, device 511 monitors link 502. For example, device 511 could monitor for the total bandwidth available over link 502. Device 511 could also monitor general performance statistics, such as packet jitter and packet delay. The performance results, such as jitter or delay, could be indicative of the performance of link 501, link 502, or communication network 530. Importantly, device 511 determines by monitoring and detection the state of the access at device 511, regardless of whether any degradation is caused by link 502, link 501, or communication network 530. Device 511 then generates access state information pertaining to the health or status of the access as perceived by device 511 and transmits the access state information to session control system 520.

Next, device 511 transmits a service request for a service to session control system 520 identifying the service and device 511. In response to the service request, session control system 520 transfers a service request to service provider system 540 indicating device 511, the requested service, and the access state information. Service provider system 540 receives the service request from session control system 520 and responsively provides service options to device 511. Device 511 provides the options to a user for selection, such as via a graphical user interface. The user selects one of the service options and device 511 transmits the selected option to service provider system 540. Upon receiving the selected option, service provider system 540 provides the requested service configured for the option selection.

Thresholds may be established that may be stored in device 511, access system 512, session control system 520, or service provider system 540. Such thresholds may be associated with data such as a particular packet flow quality, level of bandwidth availability, amount of jitter, length of delay or latency, packet loss, voice quality, or any other metric or indicator of current or predicted quality of service or performance of communication between device 511 and communication network 530 or another device or network node with which device 511 is communicating (any such data being referred to hereafter as “performance data”). In such a manner, the quality of service and performance over both links 501 and 502 can be monitored and predicted both separately and in combination. Such thresholds may be established to be indicative of current or predicted quality of service or performance. Thresholds may be absolute thresholds or thresholds that are dynamically determined and modified. For example, a threshold may be established based on some level or type of performance data known to be associated with poor communication or some other characteristic of performance data. Alternatively, a threshold may be established based on previous performance data collected by device 511, either alone or in combination with a time stamp or elapsed period of time associated with the time such previous performance data was collected. In such a manner, trends in performance data associated with device 511 or links 501 and 502 may be utilized to track a deteriorating communication session or connection or predict a more serious issue such as a dropped connection or unacceptable level of packet loss or delay.

Performance data may be collected by any or all of device 511, access system 512, session control system 520, and service provider system 540. Some performance data may be better collected by particular elements of FIG. 5. For example, device 511 may collect the data that is most relevant to assessing the overall connection over links 501 and 502 in combination, as device 511 may be best situated to collect data most closely associated with how the user of such device 511 experiences the effects of data communicated over communication network 530, link 501, and link 502. Performance data may be compared to one or more thresholds or otherwise analyzed or modeled for purposes of monitoring or predicting quality of service or performance. Such comparison, analysis, monitoring, and prediction may be accomplished by device 511, access system 512, session control system 520, or service provider system 540, either alone or in combination.

If it is determined that one or more thresholds have been crossed by the collected performance data, one or more events may be initiated by any of the elements of FIG. 5. Such events may include call handling procedures, providing feedback to a user, and the presentation of options to a user as to how to proceed with a particular communications session. More particularly, a user may be queried via device 511 if such user wants to make no changes, terminate or reinitiate a communications session or application, switch to another network mode (e.g., change from a WLAN to a cellular network), change a communications protocol, allocate a smaller amount of bandwidth to a particular application, change a CODEC utilized, batch a data transfer for later communication, queue a particular application or data transfer until performance conditions improve, or any other suitable change that may effect communication performance. Alternatively, an application may reside in device 511 or elsewhere in the elements of FIG. 5 to automatically make such determination based on rules or options previously established by a network administrator, service provider, or the user of device 511.

For example, a handheld wireless device may be progressively losing bandwidth availability or performance due to a decline in the access or backhaul technology being employed. A user of the device may change geographic location, enter a structure, or enter a region with heavy user traffic or wireless interference. If a user is communicating using both voice and video, the device may prompt the user such that the user is alerted of the decline in packet flow quality and ask if such user would like to switch to voice only communications. Alternatively, the device may automatically drop the video connection or queue it until a sufficient amount of bandwidth or quality packet transport is reestablished. Further, if a video and voice session with two participants other than the user is being conducted, the device may automatically determine which of the video connections connecting the user to one of the two participants is to be terminated based on preference previously selected by the user. In fact, the user may elect to prioritize, rank or otherwise express a preference for packets associated with a video connection with party 1, an audio connection with party 1, a video connection with party 2, and an audio connection with party 2. The device may then terminate, queue, and reestablish such connections in accordance with the user's preferences as the amount of available quality packet bandwidth of the connection of the user's device increases and decreases in strength. Although the above example is presented in terms of video and audio communications, it is equally applicable to the prioritization and selective termination and queuing of any applications communicating over a network.

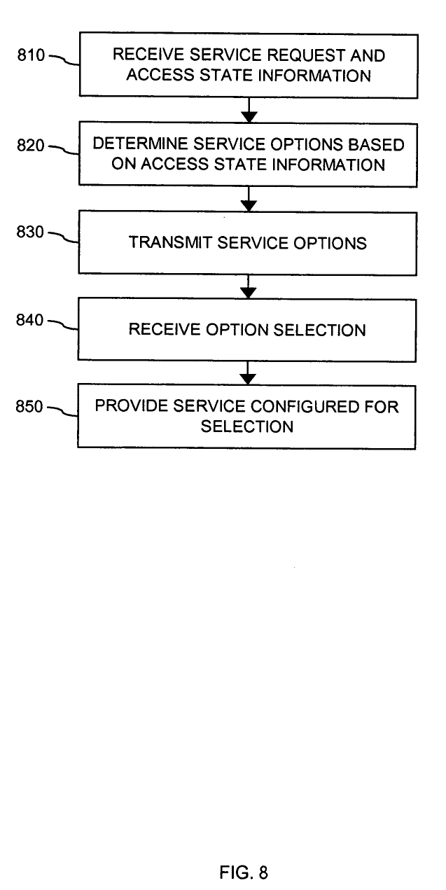

FIG. 8 illustrates the operation of service provider system 540. To begin, service provider system 540 receives the service request from session control system 520 identifying device 511, the requested service, and the access state information (Step 810). Next, service provider system 540 determines service options based on the access state information (Step 820). For example, service provider system 540 could determine various possible codec protocols to use for the service based on the available bandwidth indicated in the access state information. Service provider system 540 transmits the service options to device 511 (Step 830) whereby a user selects one of the options. Service provider system 540 receives the selected option from device 511 (Step 840) and provides the service configured for the selected option (Step 850).

As illustrated, communication network 500 advantageously allows a service provider to dynamically interact with an end user in order to optimally configure a requested service. In addition, communication network 500 provides for the forwarding of access state information on per-service request basis from a session control system to a service provider. In this manner, a device or an access system need not have awareness of a service provider while still allowing the service provider to use the access state information service optimization.

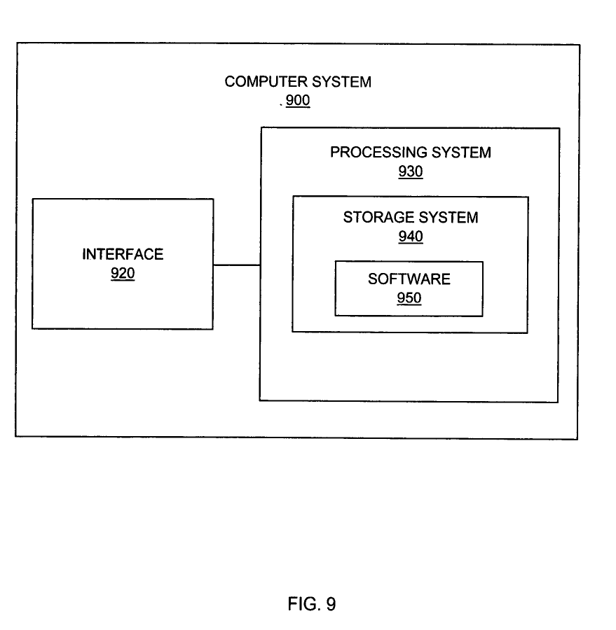

FIG. 9 illustrates computer system 900 in an embodiment of the invention. Computer system 900 includes interface 920, processing system 930, storage system 940, and software 950. Storage system 940 stores software 950. Processing system 930 is linked to interface 920. Computer system 900 could be comprised of a programmed general-purpose computer, although those skilled in the art will appreciate that programmable or special purpose circuitry and equipment may be used. Computer system 900 may use a client server architecture where operations are distributed among a server system and client devices that together comprise elements 920-950.

Interface 920 could comprise a network interface card, modem, port, or some other communication device. Interface 920 may be distributed among multiple communication devices. Interface 930 could comprise a computer microprocessor, logic circuit, or some other processing device. Processing system 930 may be distributed among multiple processing devices. Storage system 940 could comprise a disk, tape, integrated circuit, server, or some other memory device. Storage system 940 may be distributed among multiple memory devices.

Processing system 930 retrieves and executes software 950 from storage system 940. Software 950 may comprise an operating system, utilities, drivers, networking software, and other software typically loaded onto a general-purpose computer. Software 950 could also comprise an application program, firmware, or some other form of machine-readable processing instructions. When executed by the processing system 930, software 950 directs processing system 930 to operate as described above for the elements of communication network 100 or communication network 400.

What is claimed is:

1. A method of operating a service provider system, the method comprising:
receiving a state message from an access system indicating state information for access wherein the access system provides a device with the access;
receiving a service request from the device identifying the device and the service;
determining a plurality of service options for the service based on the state message;
generating a service response indicating the plurality of service options; and
transmitting the service response.

2. The method of claim 1 further comprising receiving a selection message indicating a selected service option of the plurality of service options and configuring the service for the selected service option.

3. The method of claim 2 wherein the state information comprises available bandwidth.

4. The method of claim 3 wherein the plurality of service options comprise a plurality of coding/decoding protocols.

5. The method of claim 4 wherein the access system comprises a modem.

6. The method of claim 5 wherein the service comprises a video service.

7. The method of claim 5 wherein the service comprises a voice service.

8. A service provider system comprising:
an interface configured to receive a state message from an access system indicating state information for access wherein the access system provides a device with the access, receive a service request from the device identifying the device and the service, and transmit a service response; and
a processing system configured to determine a plurality of service options for the service based on the state message and generate the service response indicating the plurality of service options.

9. The service provider system of claim 8 wherein the interface is further configured to receive a selection message indicating a selected service option of the plurality of service options and wherein the processing system is further configured to configure the service for the selected service option.

10. A communication system comprising:
a device;
an access system configured to provide the device with access to a service; and
a service provider system configured to provide the service to the device;
wherein the access system transmits a state message indicating state information for the access;
wherein the device transmits a service request to the service provider system identifying the device and the service;
wherein the service provider system receives the service request, determines a plurality of service options for the service based on the state message, generates a service response indicating the plurality of service options, and transmits the service response.

11. The communication system of claim 10 wherein the device receives the service response, generates a selection message indicating a one service option of the plurality of service options, and transmits the selection message.

12. The communication system of claim 11 wherein the service provider system receives the selection message and configures the service for the one service option.

13. The communication system of claim 12 wherein the state information comprises available bandwidth.

14. The communication system of claim 13 wherein the plurality of service options comprise a plurality of coding/decoding protocols.

15. The communication system of claim 14 wherein the access system comprises a modem.

16. The communication system of claim 15 wherein the service comprises a video service.

17. The communication system of claim 15 wherein the service comprises a voice service.

18. A method of monitoring the connection of an end user device to a network, wherein the connection includes at least two communication links, the method comprising:
collecting performance data associated with the connection;
comparing the performance data to a threshold, the threshold being associated with a particular characteristic of the performance data; and
presenting at least one option to a user of the end user device in response to the comparison, the at least one option being associated with a change in an application being processed by the end user device, the application being associated with data communicated by the end user device over the connection.

19. The method of claim 18, wherein the at least two communication links include a wireless link and a wired link, and wherein collecting the performance data further includes collecting data associated with an amount of bandwidth available to the end user device over the connection.

20. The method of claim 18, wherein the method further comprises terminating the application in response to the selection of the at least one option.
